(19) United States
(12) Patent Application Publication
(10) Pub. No.: US 2004/0016157 A1
(43) Pub. Date: Jan. 29, 2004

(54) Tamper-proof device for signage system

(76) Inventor: Erik Broos-Godts, Diest (BE)

Correspondence Address: William M. Lee, Jr., Lee, Mann, Smith, McWilliams, Sweeney & Ohlson, P.O. Box 2786, Chicago, IL, 60690, US

(21) Appl. No.: 10/207,722

(22) Filed: Jul. 29, 2002

(51) Int. Cl. G09F 7/00

(52) U.S. Cl. 40/584

(57) ABSTRACT

A tamper-proof signage device is described which comprises a sign side support element, a sign plate (31) in the form of a channel with at least two members (34a, 34c) extending perpendicular to the plate (31), clipping legs (33) for supporting the sign plate (31) and for clipped retainment of the members (34a, 34c) and a securing device (40) for forcing the clipping legs (33) into close abutment with the members (34a, 34c). The securing device (40) is adapted to prevent unclipping of the sign plate (31) by preventing deformation of the clipping legs (33) when an unclipping force is applied to the sign plate (31).

### TECHNICAL FIELD OF THE INVENTION

The present invention relates to a securing device for mounting sign plates to prevent tampering. More particularly the securing device is a two-part securing device for mounting indoor or outdoor sign plates.

### BACKGROUND OF THE INVENTION

It is known to mount indoor sign plates in a way as shown in FIG. 1 and FIG. 2.

FIG. 1 shows a known device to mount two sign plates 11a, 11b back to back. Two side pieces 12a, 12b are provided, which each have protruding legs 13. A right-handed x,y,z co-ordinate system is introduced as shown on FIG. 1. Both sign plates 11a, 11b are extruded in the form of a channel with three longitudinal fins extending perpendicular to the sign plate 11a, 11b, an upper member 14a, a middle member 14b and a lower member 14c. Sign plate 11a lies in an xz-plane, with the three members 14a, 14b, 14c extending in the negative y-direction. Also sign plate 11b lies in an xz-plane, with the three members 14a, 14b, 14c extending in the positive y-direction. Sign plates 11a, 11b are oriented with respect to each other such that corresponding members are oriented towards each other, i.e. upper members 14a are oriented towards each other, middle members 14b are oriented towards each other and lower members 14c are oriented towards each other.

The side pieces 12a, 12b lie in a yz-plane, and the protruding legs 13 lie in an xz-plane.

Such back to back mounted sign plates 11 are used for suspended sign plates or for sign plates mounted transversely to a wall.

In order to mount the sign plates 11a, 11b back to back transversely to a flat support such as a side post, a first side wall 12a is fixed to the support, e.g. by screwing. A first sign plate 11a is slid in the positive x direction so that its members 14a, 14b, 14c slide onto legs 13 of the side wall 12a. A first sign plate 11a is clipped with its members 14a, 14b, 14c onto legs 13 of the side wall 12a. It is thereafter rather difficult to mount the second sign plate 11b due to deformation of the legs 13. Once this second sign plate 11b is mounted, a second side wall 12b is introduced in the positive x-direction to close off the sign plates 11a, 11b and to secure their ends. It is rather difficult to mount the second sign plate 11b by sliding as the tolerances are of necessity rather tight. Each leg 13 of the side walls 11a, 12b is introduced between a set of two members 14a, 14b; 14b, 14c of one of the sign plates 11a, 11b. Preferably each of the legs 13 slides into a groove 15 in a member 14a, 14b, 14c.

It is a disadvantage of this system that passengers-by can easily remove the side wall 12b, and thereafter take away sign plates 11a and/or 11b.

FIG. 2 shows a known sign plate for mounting indoor sign plates 21. The sign plate 21 represented, comprises a flat sign plate 21a, e.g. for allowing lettering on its front face, and two slide plates 21b for sliding insertion of a separate inscribed plate.

Mounting such indoor sign plates 21 is carried out as follows. In a first step, side pieces 22 (only one represented) are fixed onto a supporting substrate such as a wall or a door, e.g. by screwing, with an adequate spacing between them in the y-direction, in order to receive the sign plate 21. The side walls 22 are provided with legs 23 which extend in the negative x-direction. The different parts 21a, 21b of the sign plate 21 are clipped onto the legs 23 of the side walls 22 for mounting the sign plate 21.

It is a disadvantage of this latest system that parts of the sign plate, e.g. flat sign plate 21, which is mounted at the upper part, are easily removed of a passerby, and are therefore susceptible to theft or damage. Once the uppermost sign plate is removed, the next uppermost sign plate can be removed as well, and so on.

It is an aim of the present invention to provide a system for easily mounting sign panels back to back.

It is an aim of the present invention to provide a system for mounting indoor sign panels which is less susceptible to theft.

### SUMMARY OF THE INVENTION

The above objectives are accomplished by a tamper-proof signage device according to the present invention. This tamper-proof signage device comprises: a sign side support element, a sign plate in the form of a channel with at least two members extending perpendicular to the plate, clipping legs for supporting the sign plate and for clipped retainment of the members and a securing device for forcing the clipping legs into close abutment with the members.

The sign support element, the clipping legs and the securing device may all be separate units. Alternatively, the sign side support element and the securing device may be formed in one piece, and the clipping legs may be a separate piece. Alternatively, the side support element and the clipping legs may form one piece, and the securing device may be a separate piece. To provide a tamper-proof signage device the clipping legs and the members of the sign plate may have mutually interfering and engaging parts for clipping engagement with each other. The engaging parts may be grooves and ridges. The securing device may have a wedge-shaped outer or inner surface. The securing device is adapted to prevent unclipping of the sign plate by preventing deformation of the clipping legs when an unclipping force is applied to the sign plate. The securing device is preferably hidden by the sign plate and the side support element.

The present invention may also provide a method for a securing a tamper-proof signage device, the signage device comprising:

a side support element, a sign plate in the form of a channel with at least two members extending perpendicular to the plate, clipping legs for the sign plate to be in clipped arrangement with the members, the method comprising the step of:

holding the clipping legs in close abutment with the members by forced insertion of a securing device to prevent distortion of the clipping legs when an unclipping force is applied to the sign plate.

Other features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 is a perspective view of a known system for mounting sign panels back to back.

FIG. 2 is a perspective view of a known system for mounting a sign panel against a support such as a wall.

FIG. 3A is a front view of a side wall with protruding legs for clipping a sign plate onto, FIG. 3B is a side view, and FIG. 3C is a bottom view thereof in accordance with an embodiment of the present invention.

FIG. 4A is a front view of the side wall with protruding legs of FIG. 3A, with two sign plates mounted thereon back to back, FIG. 4B is a side view and FIG. 4C is a bottom view thereof. FIG. 4D is a front view of a securing device according to an embodiment of the present invention.

FIG. 5A is a cross-sectional view of a sign plate mounted on clipping legs, the sign plate having four members for engaging with the clipping legs in accordance with an embodiment of the present invention. FIG. 5B is a cross-sectional view according to B-B′ in FIG. 5A, showing an embodiment of a securing device according to the present invention.

FIG. 6A is a vertical cross-sectional front view and FIG. 6B is a side view of an embodiment according to the present invention of a sign plate clipped onto legs and secured by a securing device.

FIG. 7A is a front view and FIG. 7B is a top view of an embodiment of the present invention with a side wall and a plurality of securing devices forming one piece.

FIG. 8A is a front view, FIG. 8B a side view and FIG. 8C a top view of a clipping leg unit in accordance with an embodiment of the present invention.

FIG. 9 is a diagrammatic cross-sectional top view of the clipping leg unit of FIG. 8A-8C, onto which a sign plate is clipped, which sign plate is secured by a securing device which forms one piece with a side wall.

FIG. 10 shows the use of a special key for clipping out exchangeable sign plates.

FIG. 11A and FIG. 11B are cross-sectional views of an embodiment of the present invention in which a system for placing e.g. name tags or function tags on portable signage makes use of a combination of a securing device, a side wall, clipping legs and an extruded sign plate provided with protruding members.

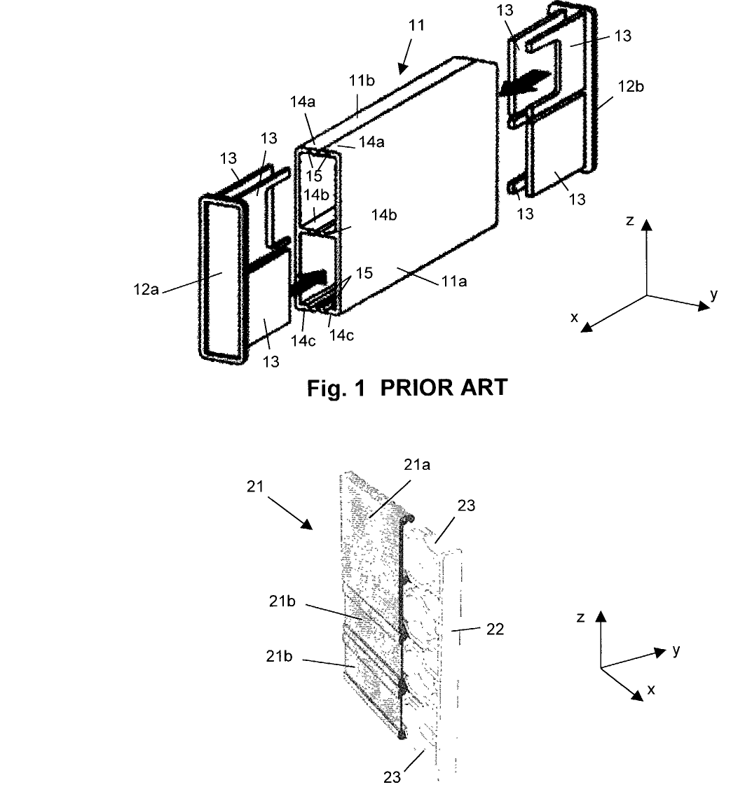

In the different drawings, same or analogous elements bear the same reference number.

### DESCRIPTION OF THE ILLUSTRATIVE EMBODIMENTS

The present invention will be described with respect to particular embodiments and with reference to certain drawings but the invention is not limited thereto but only by the claims. The drawings described are only schematic and are non-limiting. An arbitrary Cartesian reference co-ordinate system is shown in the figures which is merely used for clarity purposes.

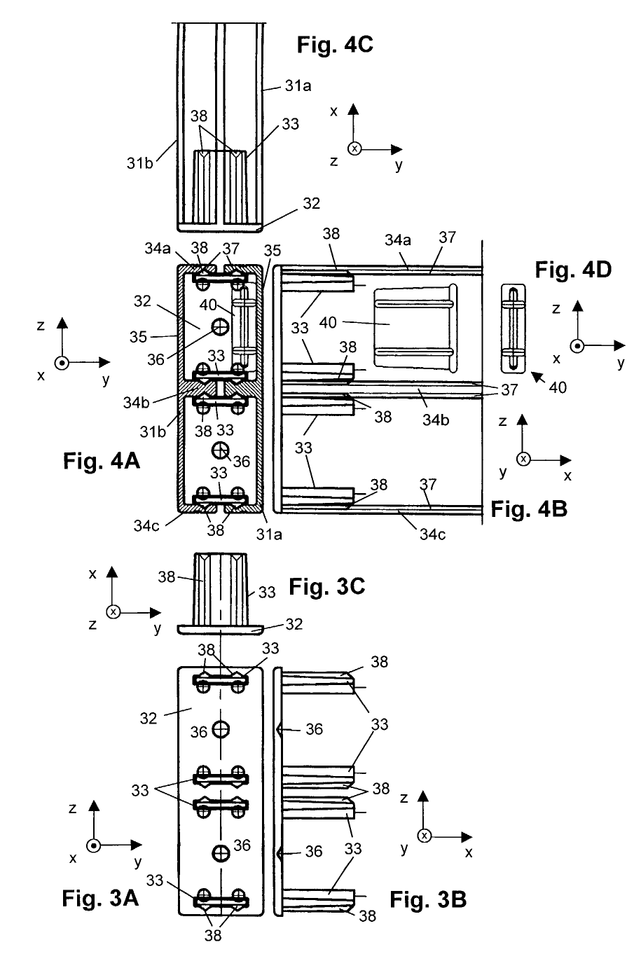

FIGS. 3A, 3B and 3C show a front view, a side view and a bottom view of a side wall 32 with four protruding clipping legs 33 in accordance with an embodiment of the invention. The side wall and clipping legs will typically be made of plastic by injection moulding or, for instance of aluminium by die casting, and are adapted for supporting a sign plate. The clipping legs are preferably made from a flexible material so that they can develop the clipping action for holding a sign plate by movement. The side wall may also be made from a more rigid material such as aluminium but in this case the tolerances must be much more exact as the amount of interference with a sign plate member is much reduced. The side wall 32 lies in a yz-plane, and the protruding legs lie in an xy-plane and substantially extend in the x-direction. The side wall 32 and the clipping legs 33 may form one unit or piece.

Such a side wall 32 with protruding clipping legs 33 can be used for back to back mounting of sign plates 31a, 31b as shown in FIG. 4A, either for a free hanging system of indoor sign plates, or for back to back mounting sign plates transversely to e.g. a support such as a post or wall. Pits or holes 36 are preferably provided in the back plate of the side wall 32 to allow screwing of the side wall 32 onto a carrying support such as a post or wall.

Sign plates 31a, 31b are preferably shaped in such a manner that they can be made by extrusion without excessive post-processing, e.g. only requiring cutting to length and de-burring if necessary. The sign plates are preferably made of a rigid material such as a metal, e.g. aluminium. Such sign plates may be in the form of a channel with a plurality of longitudinally extending members, e.g. three members 34a, 34b, 34c which may extend the whole length of the sign plate. They may also extend substantially perpendicularly to a substantially flat or suitably shaped base plate which forms the main surface area for signage. For instance, the two outer members 34a and 34c may form one surface of the completed signage device. Such sign plates can be made from aluminium by extrusion. A front signage face 35 of the sign plate 31a, 31b lies substantially in an xz-plane, and the three members 34a, 34b, 34c lie in an xy-plane. The sign plates 31a, 31b clip and/or slide with their members 34a, 34b, 34c onto the legs 33 of the side wall 32 preferably in a retaining manner for the sign plate 31.

Preferably the legs 33 and the members 34a, 34b, 34c have engaging parts which mutually interfere with each other and engage each other such as to resist unclipping forces exerted on the sign plates to a certain extent. The engaging parts represented in FIG. 4A are grooves 37 in the members 34a, 34b, 34c co-operating with ridges 38 on the clipping legs 33 to prevent removal of a sign plate 31a, 31b in the y direction without exertion of enough force to make the ridges 38 ride out of the grooves 37 by deformation of the legs 33. Other interfering forms and shapes are known to the skilled person and are included within the scope of the present invention and may be used interchangeably with the described items.

Once one sign plate 31a has been slid into or clipped with its members 34a, 34b, 34c onto the legs of the side wall 32, a securing device 40 is introduced for securing the positioning of the sign plate 31a onto the clipping legs 33, e.g. by sliding a wedge in the x direction until it is jammed in between the legs 33. Once a second sign plate has been clipped to the side wall, it forms with the first sign plate a closed tubular space. To introduce a second securing device for the second sign plate a tool can be used which is introduced along the length of the second sign plate for delivery of the securing device 40 to its location between the relevant clipping legs of the side wall.

One embodiment of such a securing device 40 is shown in FIG. 4A, 4B and 4D. This securing wedge is introduced between two clipping legs 33, and its tapered shape pushes the clipping legs 33 away from each other during insertion, thus pushing the ridges on the legs 33 in closer forced engagement with the grooves 37 in the members 34. The securing device 40 is wedge shaped at its outer surface, decreasing in size in the direction of insertion. By wedging in between the legs 33, removal of a sign plate 31 is made very difficult as deformation of legs 33 is prevented. The securing device may be made from any suitable device, e.g. plastic or metal.

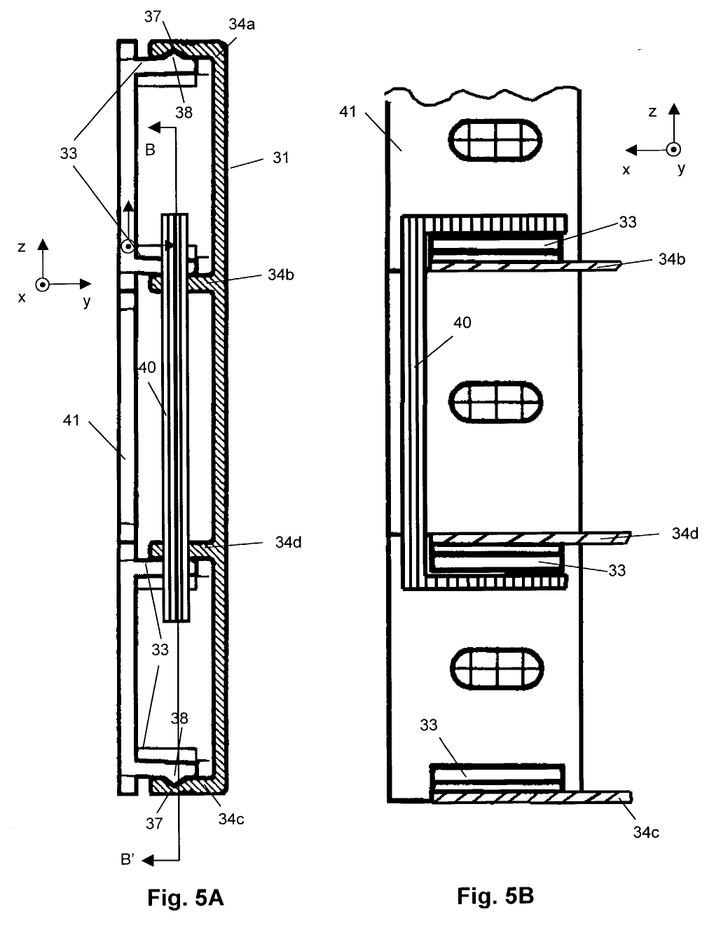

According to another embodiment, represented in FIGS. 5A and 5B, the securing device 40 may also be in the form of a fork which is introduced onto the outside of two legs 33, thus restraining legs 33 in close engagement with the respective members 34b, 34d and preventing deformation of the legs 33.

According to another embodiment, not represented, if the sign plate is not made of a rigid material, but is made from slightly flexible material, the securing device may also be introduced between two members of the sign plate, thus pushing the members away from each other, and in closer engagement with the respective clipping legs onto which the members are clipped.

Still other embodiments (not represented) are possible, e.g. in which the members clip onto the clipping legs from the inside (contrary to the shown embodiments, where the members clip onto the outside of the clipping legs). The securing device may be pushed between two clipping legs, between two members or between a clipping leg and a member, or it may be pushed around two clipping legs, around two members or around a clipping leg and a member. In all cases, the securing device forces at least one clipping leg into close abutment with a corresponding member.

A function of the securing device 40 is to keep a co-operating fixing member of a sign plate and a clipping leg of a side wall in close forced engagement. If the securing device 40 is pushed around two clipping legs as shown in FIGS. 5A and 5B, around two members or around a clipping leg and a member, it may be in the form of fork with two or more legs which may define a tapered space between them. The securing device 40 then has a tapering inner surface.

In the above embodiments the sign plates, when back-to-back and attached to side walls define an enclosed space in which the securing device is hidden from view.

FIGS. 5, 6 and 7 show an embodiment of the present invention in which the clipping legs do not form one piece with the side wall.

A back plate 41 is provided with at least two clipping legs 33. The back plate 41 is provided for being attached, e.g. by screwing, to a carrying substrate, such as e.g. a wall. The clipping legs of the back plate may be made from a flexible material such as a plastic. The back plate 41 lies in the xz-plane, with the clipping legs 33 lying in the xy-plane and extending substantially in the y-direction. The sign plate 31 lies in an xz-plane, with protruding and longitudinally extending members 34a, 34b, 34c, 34d, which clip over the corresponding clipping legs 33 of the back plate 41. The sign plate is preferably made from a rigid material such as a metal, e.g. aluminium.

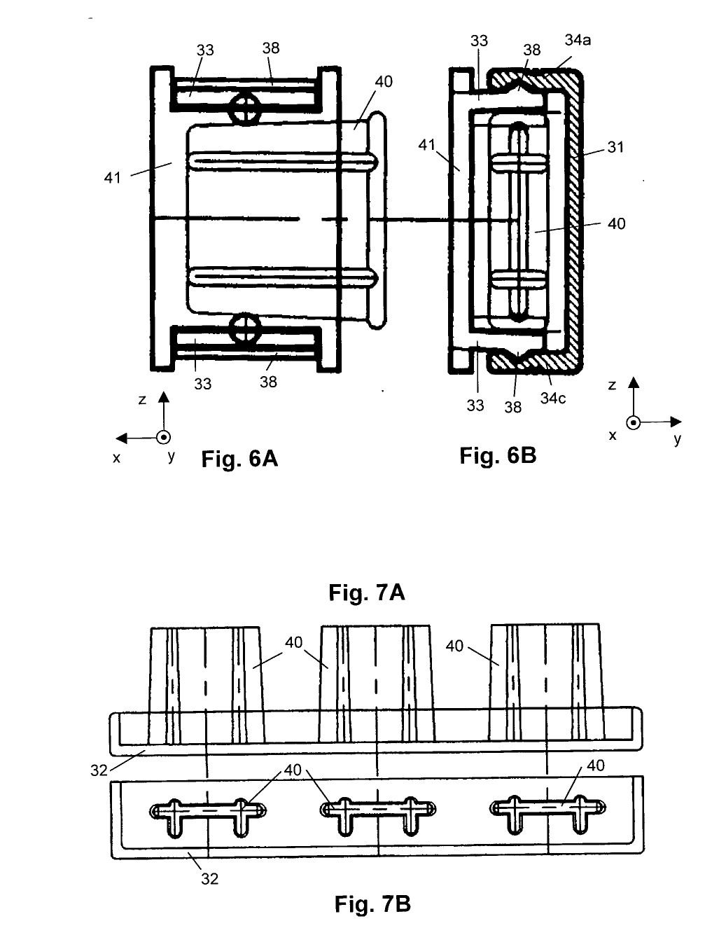

According to embodiments of the present invention, the sign plate 31 mounted on the clipping legs 33 can be secured by introducing a securing device 40. In the embodiment of FIGS. 6A and 6B, the securing device 40 is introduced between two clipping legs 33 and preferably has a wedge shape, thus pushing these clipping legs 33 away from each other and into close forced engagement with the members 34a, 34c of the sign plate 31. In the embodiment of FIGS. 5A and 5B, the securing device 40 is introduced around two clipping legs 33, thus pushing these clipping legs 33 towards each other and in close engagement with the corresponding clipping legs 33. According to further embodiments (not represented), the securing device 40 can be introduced between two members, around two members, between a clipping leg and a member, or around a clipping leg and a member. In all cases, the aim of the securing device 40 is to bring a member of a sign plate and its corresponding clipping leg on the back plate 41 into close cooperation, so as to make it more difficult to take off the sign plate from the clipping legs.

In the embodiment of FIG. 6, the side wall, the clipping legs 33 and the securing wedge 40 are all separate units. In the above embodiments the securing device has been shown as a separate item but the present invention is not limited thereto. In the following, the same materials may be used for manufacture of sign plates, clipping legs and securing devices as described above.

In FIG. 7 is represented a side wall 32 which forms one piece with a plurality of securing devices 40 integrally made therewith. Such a side wall 32 with securing devices 40 could, for example, be introduced at a side of the back plate 41 and sign plate 31 combination of FIG. 5A or FIG. 6B in order to secure the mounting. Sign plates 31 secured that way cannot easily be removed. A side wall 32 with securing devices 40 must have an appropriate length, corresponding to the height in the z-direction of the sign system.

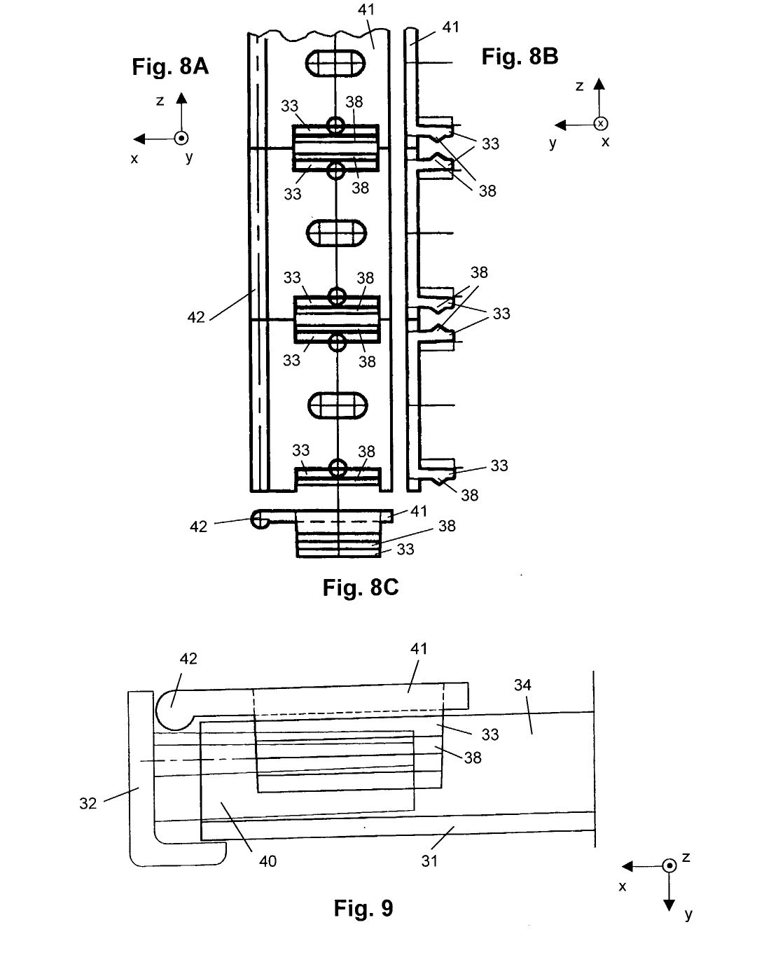

FIG. 8A is a front view of a back plate 41 with a series of clipping legs 33. The back plate 41 lies in an xz-plane. The clipping legs 33 lie substantially in an xy-plane, extending in the positive x-direction. The back plate 41 is preferably provided with a plurality of pits or holes 36 for attaching the back plate 41, e.g. by screwing, onto a carrying substrate such as a wall. In another embodiment (not represented), two such back plates 41 can be connected back to back onto each other, e.g. by screwing, gluing, welding, etc. or may be formed integrally in this way. The back plate 41 is provided with a protruding part 42, which may be cylindrical, cube-shaped, or may have any suitable form, e.g. polygonal in cross-section.

FIG. 8B is a side view of the back plate 41 with clipping legs 33 represented in FIG. 8A. A sign plate with protruding members (not represented in FIG. 8A nor in FIG. 8B) is intended to be clipped onto the clipping legs, so as to lie in an xz-plane.

FIG. 9 shows a top view of a back plate 41 as in FIG. 8A, which may be connected to a carrying substrate (not represented). A sign plate 31 with protruding members 34 is clipped onto clipping legs 33 of the back plate 41. After having connected the sign plate 31 or sign plates onto the clipping legs 33, side walls 32 with integral securing devices 40 having e.g. a wedge form or a fork form as explained above, may be introduced at either side of the sign plates in the x-direction. As shown in FIG. 5B and FIG. 6A, and as explained above, the securing devices 40 may be of different forms each form of which is a separate embodiment of the present invention. They may push against different parts of the back plate 41—sign plate 31 combination, they may be separate parts, or they may form one unit with the side wall 32 as represented in FIG. 9. The aim of the securing devices 40 is to keep at least some of the clipping legs 33 and their corresponding members 34 of the sign plate 31 in close co-operation and to make removal of the sign plate 31 by unclipping more difficult.

The function of the protruding part 42 is to form a stop so as to align the side walls 32 with respect to the sign plates 31 so that they are in a predetermined positional relationship therewith.

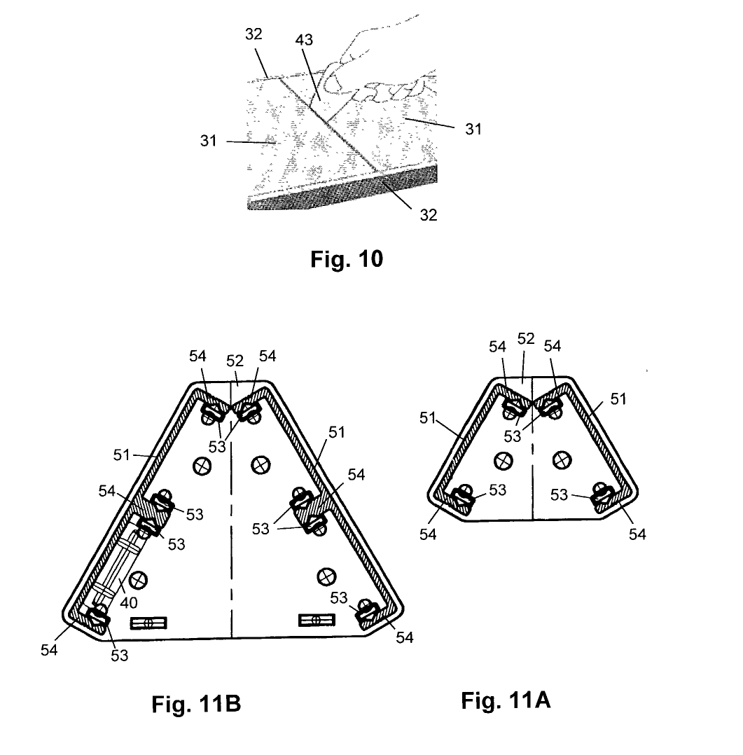

It is not necessary that all clipping legs 33 are kept in close co-operation with the respective protruding members 34 of the sign plate 31. If it is desired that a sign system with exchangeable sign plates 31 is obtained, it is sufficient to secure the upper and lower sign plate of a series of the system by means of securing devices 40, either by securing devices 40 introduced as a separate piece, or by securing devices 40 which are integral with the side walls 32. All other sign plates 31 may just be clipped onto the clipping legs 33, without being secured by a securing device 40. If one of the intermediate sign plates 31 has to be exchanged, it may be unclipped by using a special key 43 as represented in FIG. 10, and a replacement sign plate may be clipped in.

Of course, some of the intermediate sign plates may also be secured by means of securing devices, either by separate securing devices or by securing devices which are integral with the side walls. A common feature of all the security devices 40 of the present invention is that they are not easily visible when the sign plates are all located. Hence, the presence of the security devices remains hidden from view and difficult to access once installed.

One sign panel may comprise one or a plurality of sign plates, of different or same dimensions in the z-direction.

Another embodiment of the present invention is as shown in FIG. 11A and FIG. 11B. Both are cross-sectional views of systems for placing e.g. name tags or function tags on e.g. a desk. The embodiment of FIG. 11A is smaller than the embodiment of FIG. 11B. A substantially triangular side wall 52 lies in a yz-plane and is provided with protruding clipping legs 53 perpendicular thereto. The side wall 52 and the clipping legs 53 form one piece. Sign plates 51, each having at least two protruding members 54, clip onto the clipping legs 53 almost as in the embodiment of FIG. 4 (but no real back to back mounting). According to the present invention, the mounting of the sign plates 51 onto the clipping legs 53 is secured by means of at least one securing device 40 typically wedge-shaped (not represented in FIG. 11A). This securing device 40 is a separate piece which may be introduced between two clipping legs, between two members, around two clipping legs, around two members or around a combination of a clipping leg and a corresponding member, in order to keep clipping legs and members of the sign plate into close abutment as explained above.

While the invention has been shown and described with reference to preferred embodiments, it will be understood by those skilled in the art that various changes or modifications in form and detail may be made without departing from the scope and spirit of this invention.

1.- A tamper-proof signage device comprising
a sign side support element (32),
a sign plate (31a) in the form of a channel with at least two members (34a, 34b, 34c) extending perpendicular to the plate (31a),
clipping legs (33) for supporting the sign plate (31a) and for clipped retainment of the members (34a, 34b, 34c) and
a securing device for forcing the clipping legs into close abutment with the members (34a, 34b, 34c).

2.- A tamper-proof signage device according to claim 1, wherein the sign side support element (32) and the securing device (40) form one piece, and the clipping legs (33) are a separate piece.

3.- A tamper-proof signage device according to claim 1, wherein the side support element (32) and the clipping legs (33) form one piece, and the securing device (40) is a separate piece.

4.- A tamper-proof signage device according to claim 1, wherein the clipping legs (33) and the members (34a, 34b, 34c) of the sign plate (31a) have mutually interfering and engaging parts (37, 38) for clipping engagement with each other.

5.- A tamper-proof signage device according to claim 4, wherein the engaging parts are grooves (37) and ridges (38).

6.- A tamper-proof signage device according to claim 1, wherein the securing device (40) has a wedge-shaped outer surface.

7.- A tamper-proof signage device according to claim 1, wherein the securing device (40) has a wedge-shaped inner surface.

8.- A tamper-proof signage device according to claim 1, wherein the securing device is adapted to prevent unclipping of the sign plate by preventing deformation of the clipping legs when an unclipping force is applied to the sign plate.

9.- A tamper-proof signage device according to claim 1, wherein the securing device is hidden by the sign plate and the side support element.

10.- A method for a securing a tamper-proof signage device, the signage device comprising
a side support element (32),
a sign plate (31 a) in the form of a channel with at least two members (34a, 34b, 34c) extending perpendicular to the plate (31a)
clipping legs (33) for the sign plate (31a) to clip into with the members (34a, 34b, 34c),
the method comprising the step of:
holding the clipping legs in close abutment with the members (34a, 34b, 34c) by forced insertion of a securing device to prevent distortion of the clipping legs when an unclipping force is applied to the sign plate.

11.- A method according to claim 10, whereby the securing device is inserted by fitting a side support element with integral securing device.
